(19) United States
(12) Patent Application Publication
(10) Pub. No.: US 2024/0141688 A1
(43) Pub. Date: May 2, 2024

(54) DOOR LOCK SYSTEM AND DRIVING MODULE THEREOF

(71) Applicant: TAIWAN FU HSING INDUSTRIAL CO., LTD., Kaohsiung City (TW)

(72) Inventor: YU-CHENG LIN, Kaohsiung City (TW)

(21) Appl. No.: 18/476,629

(22) Filed: Sep. 28, 2023

(30) Foreign Application Priority Data
Nov. 2, 2022 (TW) 111212022

(51) Int. Cl. E05B 13/10; E05B 13/00

(52) U.S. Cl. CPC E05B 13/106; E05B 13/004

(57) ABSTRACT

A door lock system includes an external handle, a locking structure and a driving module. The driving module includes a driving shaft; a driving bar penetrates through the driving shaft; a cam sleeved on the driving shaft and having a guiding inclined surface; a locking member movably arranged between the locking structure and the cam, and formed with a through hole; a sliding member slidably sleeved on the driving bar and having one end penetrates through the through hole; and a first elastic member configured to push the sliding member to abut against the guiding inclined surface. When the driving bar is rotated along a first rotation direction, the sliding member is configured to move toward the locking structure along the guiding inclined surface to push the locking member to engage with the locking structure, in order to prevent the external handle from rotating relative to the locking structure.

### BACKGROUND OF THE INVENTION

### 1. Field of the Invention

The present invention relates to a door lock system, and more particularly, to a door lock system with improved structure.

### 2. Description of the Prior Art

Generally, a tubular lock has a driving bar connected between an external lock assembly and an internal lock assembly in order to drive relevant components to perform locking and unlocking operations. Some of the conventional tubular locks have an automatic unlocking function, and the driving bar of such type of tubular lock is configured to move along an axial direction of the driving bar during the locking and unlocking operations. In consideration of the axial movement of the driving bar, such type of the conventional tubular lock requires additional accessories to prevent the driving bar from being separated from the relevant components when it moves. On the other hand, such type of the conventional tubular lock needs to reserve space required by the driving bar for the axial movement. Therefore, mechanism design of the conventional tubular lock is more complicated and has more design restrictions.

### SUMMARY OF THE INVENTION

The present invention provides a door lock system and a driving module thereof in order to solve the problems of the prior art.

A door lock system of the present invention comprises an external lock assembly and a driving module. The external lock assembly comprises an external handle and a locking structure. The driving module comprises a driving shaft configured to drive a latch to move when being rotated; a driving bar penetrating through the driving shaft and rotatable relative to the driving shaft; a cam sleeved on the driving shaft and having a guiding inclined surface; a locking member movably sleeved on the driving bar and arranged between the locking structure and the cam, wherein the locking member is formed with a through hole; a sliding member slidably sleeved on the driving bar and arranged between the locking member and the cam, wherein one end of the sliding member penetrates through the through hole; and a first elastic member configured to abut against the end of the sliding member in order to push the sliding member to abut against the guiding inclined surface; wherein when the driving bar is rotated along a first rotation direction, the sliding member is configured to move toward the locking structure along the guiding inclined surface to push the locking member to engage with the locking structure, in order to prevent the external handle from rotating relative to the locking structure.

A driving module of a door lock system of the present invention comprises a driving shaft configured to drive a latch to move when being rotated; a driving bar penetrating through the driving shaft and rotatable relative to the driving shaft; a cam sleeved on the driving shaft and having a guiding inclined surface; a locking member movably sleeved on the driving bar and arranged between a locking structure of the door lock system and the cam, wherein the locking member is formed with a through hole; a sliding member slidably sleeved on the driving bar and arranged between the locking member and the cam, wherein one end of the sliding member penetrates through the through hole; and a first elastic member configured to abut against the end of the sliding member in order to push the sliding member to abut against the guiding inclined surface; wherein when the driving bar is rotated along a first rotation direction, the sliding member is configured to move toward the locking structure along the guiding inclined surface to push the locking member to engage with the locking structure.

In contrast to the prior art, the driving module of the door lock system of the present invention is configured to drive the sliding member to axially move relative to the driving bar through rotating the driving bar, in order to further drive the locking member to engage with or disengage from the locking structure. Therefore, the driving bar of the present invention does not need to move along the axial direction. In other words, the door lock system of the present invention does not require additional accessories to prevent the driving bar from being separated from the relevant components when it moves. In addition, the door lock system of the present invention does not need to reserve space required by the driving bar for the axial movement. Therefore, mechanism design of the door lock system of the present invention is simpler and has less design restrictions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a door lock system of the present invention.

FIG. 2 is an exploded view of an external lock assembly and a driving module of the door lock system of the present invention.

FIG. 3 is a diagram showing partial components of the door lock system of the present invention.

FIG. 4 is a diagram showing partial components of the door lock system of the present invention.

FIG. 5 is a diagram showing the driving module of the present invention in an unlocking state.

FIG. 6 is a diagram showing the driving module of the present invention in a locking state.

FIG. 7 is a diagram showing a locking member of the driving module of the present invention.

FIG. 8 is a diagram showing a sliding member of the driving module of the present invention.

FIG. 9 is a diagram showing partial components of the door lock system of the present invention.

FIG. 10 is a diagram showing partial components of the door lock system of the present invention.

### DETAILED DESCRIPTION

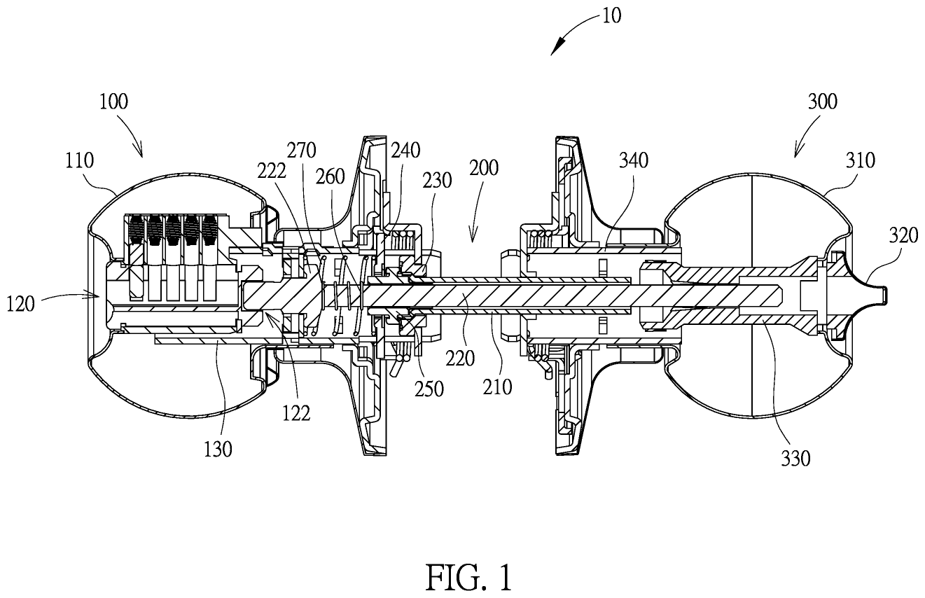

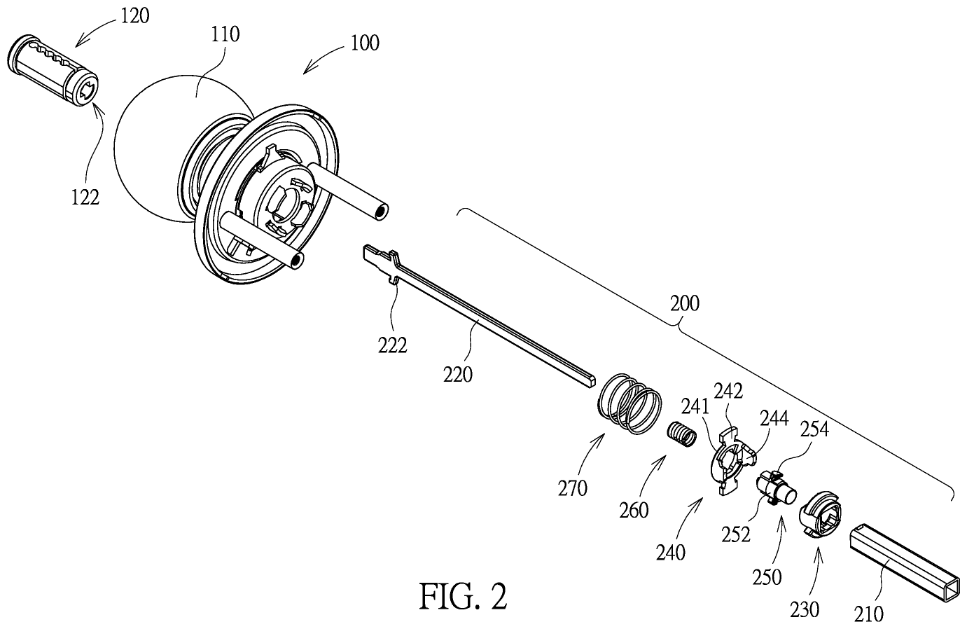

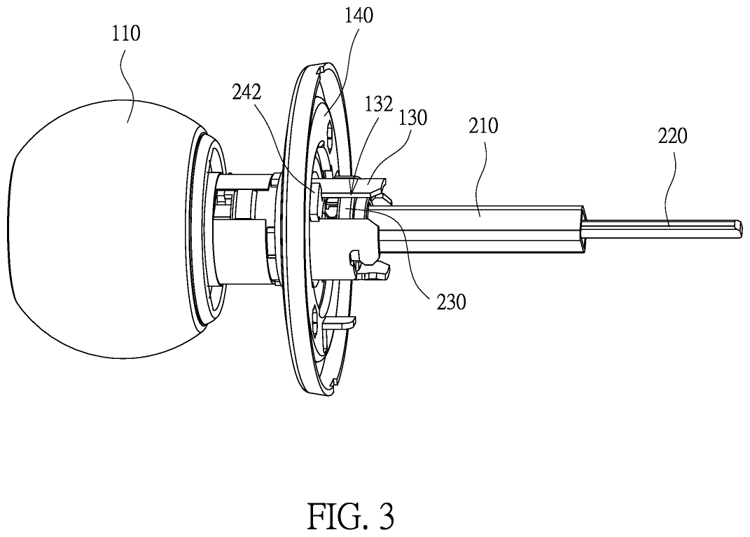

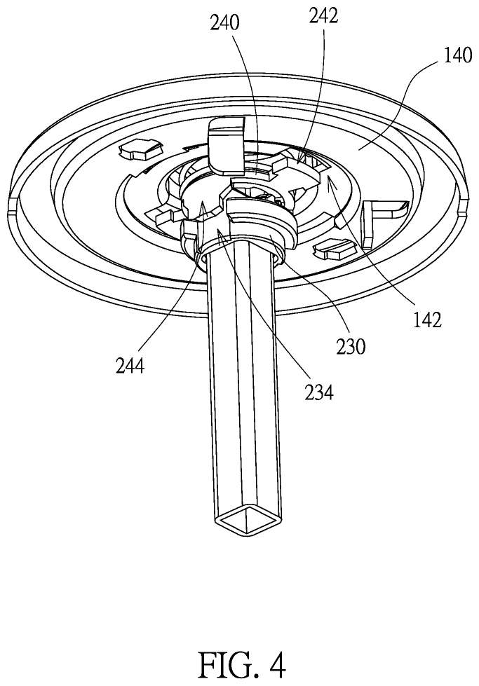

Please refer to FIG. 1 to FIG. 4. FIG. 1 is a diagram of a door lock system of the present invention, FIG. 2 is an exploded view of an external lock assembly and a driving module of the door lock system of the present invention, FIG. 3 is a diagram showing partial components of the door lock system of the present invention, and FIG. 4 is a diagram showing partial components of the door lock system of the present invention. As shown in the figures, the door lock system 10 of the present invention comprises an external lock assembly 100, a driving module 200 and an internal lock assembly 300. The external lock assembly 100 comprises an external handle 110, a lock cylinder 120, an external rotating shaft 130 and an installation fixing plate 140. The lock cylinder 120 is arranged on the external handle 110. The external rotating shaft 130 is connected to the external handle 110 configured be rotated along with the external handle 110. The installation fixing plate 140 is configured to install and fix the external lock assembly 100 on to a door panel. The installation fixing plate 140 is formed with a locking structure 142. In the present embodiment, the installation fixing plate 140 is formed with two locking structures 142, but the present invention is not limited thereto.

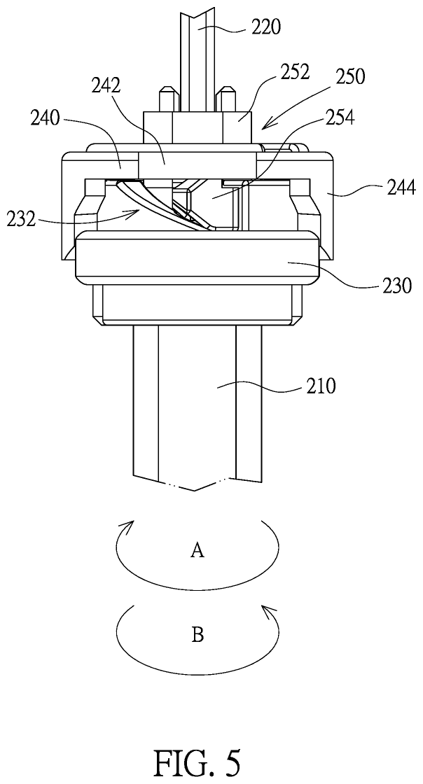

The driving module 200 comprises a driving shaft 210, a driving bar 220, a cam 230, a locking member 240, a sliding member 250, a first elastic member 260 and a second elastic member 270. The driving shaft 210 is configured to drive a latch of the door lock system 10 to move when being rotated, such as driving the latch to retract relative to the door panel. The driving bar 220 penetrates through the driving shaft 210 and is rotatable relative to the driving shaft 210. The driving bar 220 has at least one protrusion structure 222 radially protruded relative to a main body of the driving bar 220. In the present embodiment, the driving bar 220 has two protrusion structures 222, but the present invention is not limited thereto. In addition, the lock cylinder 120 of the external lock assembly 100 has an accommodation structure 122 configured to accommodate a first end of the driving bar 220, and the lock cylinder 120 is configured to drive the driving bar 220 to rotate through the accommodation structure 122 when being rotated. The cam 230 is sleeved on the driving shaft 210, and the cam 230 is formed with at least one engaging structure 234. The cam 230 is not rotatable relative to the driving shaft 210. In the present embodiment, the cam 230 is formed with two engaging structures 234, but the present invention is not limited thereto. The locking member 240 is movably sleeved on the driving bar 220 and arranged between the locking structure 142 and the cam 230. The locking member 240 comprises an annular main body 241, at least one locking part 242 and at least one engaging part 244. The annular main body 241 is formed with a through hole. The locking part 242 is radially extended relative to the annular main body 241. The engaging part 244 is axially extended relative to the annular main body 241. In the present embodiment, the locking member 240 comprises two locking parts 242 and two engaging part 244, but the present invention is not limited thereto. On the other hand, the external rotating shaft 130 is formed with slots 132. The locking parts 242 of the locking member 240 pass through the slots 132 of the external rotating shaft 130, such that the locking member 240 is configured to be axially moved along the slots 132 of the external rotating shaft 130. The sliding member 250 is slidably sleeved on the driving bar 220 and arranged between the locking member 240 and the cam 230. The sliding member 250 and the driving bar 220 are not rotatable relative to each other. One end of the sliding member 250 penetrates through the through hole of the locking member 240. The sliding member 250 comprises a main body 252 slidably sleeved on the driving bar 220, and at least one protrusion block 254 radially protruded from the main body 252. In the present embodiment, the sliding member 250 comprises two protrusion blocks 254, but the present invention is not limited thereto. The first elastic member 260 has a first end abutting against the protrusion structure 222 of the driving bar 220, and a second end abutting against the end of the sliding member 250 penetrating through the through hole of the locking member 240. The first elastic member 260 is configured to push the sliding member 250, such that the protrusion block 254 of the sliding member 250 abuts against a guiding inclined surface 232 of the cam 230 (please also refer to FIG. 5). In the present embodiment, the cam 230 is formed with two guiding inclined surfaces 232 corresponding to the two protrusion blocks 254 of the sliding member 250 respectively. The second elastic member 270 has a first end abutting against a wall surface of the external lock assembly 100, and a second end abutting against the locking member 240 and configured to push the locking member 240 to move away from the locking structure 142.

The internal lock assembly comprises an internal handle 310, a turning button 320, an internal rotating shaft 330 and an internal rotating cylinder 340. The turning button 320 is arranged on the internal handle 310. The internal rotating shaft 330 is connected between the turning button 320 and a second end of the driving bar 220. The turning button 320 is configured to drive the driving bar 220 to rotate through the internal rotating shaft 330 when being rotated. The internal rotating cylinder 340 is connected between the internal handle 310 and the driving shaft 210. When the internal handle 310 is rotated, the internal handle 310 is configured to drive the driving shaft 210 to rotate through the internal rotating cylinder 340.

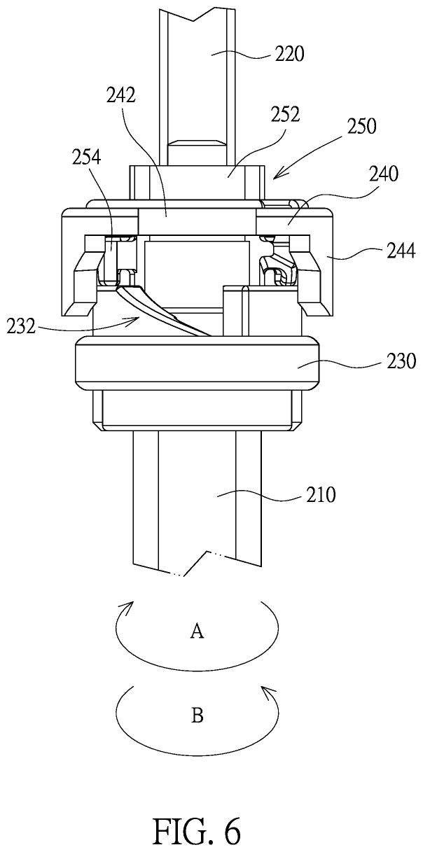

Please refer to FIF. 5 and FIG. 6, and refer to FIG. 1 to FIG. 4 as well. FIG. 5 is a diagram showing the driving module of the present invention in an unlocking state, and FIG. 6 is a diagram showing the driving module of the present invention in a locking state. When the driving module 200 is in the unlocking state, the locking part 242 of the locking member 240 is away from the locking structure 142, and the engaging part 244 of the locking member 240 is engaged with the engaging structure 234 of the cam 230. In the unlocking state, the external handle 110 can be rotated relative to the locking structure 142, to further drive the driving shaft 210 to rotate through the external rotating shaft 130, the locking member 240 and the cam 230, in order to drive the latch to move. When the driving module 200 is in the locking state, the locking part 242 of the locking member 240 is engaged with the locking structure 142, and the engaging part 244 of the locking member 240 is away from the engaging structure 234 of the cam 230. In the locking state, the external handle 110 cannot be rotated relative to the locking structure 142 since the locking part 242 of the locking member 240 is engaged with the locking structure 142. In other words, the external handle 110 is not rotatable relative to the locking structure 142.

As shown in FIG. 5, when the driving module 200 is in the unlocking state and when the driving bar 220 is rotated along a first rotation direction A, the sliding member 250 is rotated along with the driving bar 220, and the protrusion block 254 of the sliding member 250 is configured to move up along the guiding inclined surface 232 of the cam 230 accordingly, to further push the locking member 240 to move away from the cam 230 and move toward the locking structure 142 (please also refer to FIG. 4), such that the locking part 242 of the locking member 240 is engaged with the locking structure 142 (the driving module 200 is switched to the locking state shown in FIG. 6)

As shown in FIG. 6, when the driving module 200 is in the locking state and when the driving bar 220 is rotated along a second rotation direction B (the second rotation direction B is opposite to the first rotation direction A), the sliding member 250 is rotated along with the driving bar 220, and the protrusion block 254 of the sliding member 250 is configured to move down along the guiding inclined surface 232 of the cam 230 accordingly (the sliding member 250 is pushed down by the elastic force of the first elastic member 260). Furthermore, an elastic force of the second elastic member 270 pushes the locking member 240 to move away from the locking structure 240 and move toward the cam 230, such that the engaging part 244 of the locking member 240 is engaged with the engaging structure 234 of the cam 230 (the driving module 200 is switched to the unlocking state shown in FIG. 5). Accordingly, the locking part 242 of the locking member 240 is disengaged from the locking structure 142.

According to the above arrangement, when the driving bar 220 is rotated to perform locking and unlocking operations, the driving bar 220 is not moved along an axial direction of the driving bar 220. In other words, the door lock system 10 of the present invention does not require additional accessories to prevent the driving bar 220 from being separated from the relevant components when it moves. In addition, the door lock system 10 of the present invention does not need to reserve space required by the driving bar 220 for the axial movement. Therefore, mechanism design of the door lock system 10 of the present invention is simpler and has less design restrictions.

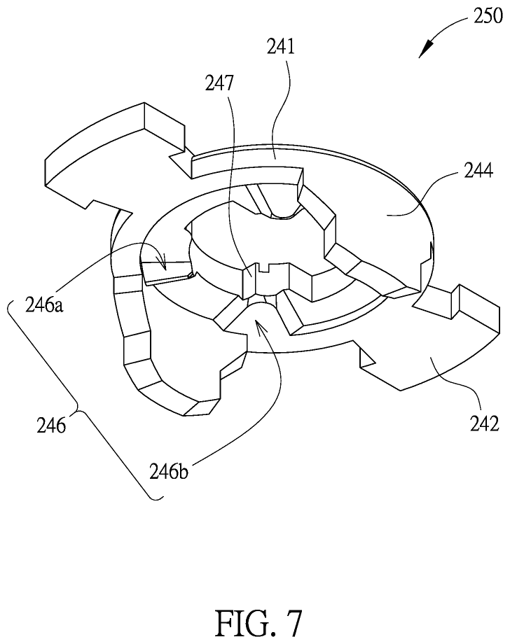

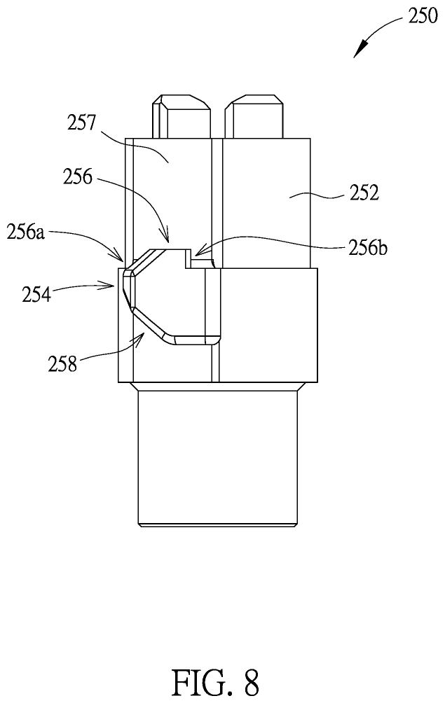

Please refer to FIG. 7 and FIG. 8, and refer to FIG. 5 and FIG. 6 as well. FIG. 7 is a diagram showing the locking member of the driving module of the present invention, and FIG. 8 is a diagram showing the sliding member of the driving module of the present invention. As shown in figures, the annular main body 241 of the locking member 240 is formed with a first blocking structure 246. The first blocking structure 246 comprises two blocking protrusions 246a, 246b. On the other hand, an upper end of the protrusion block 254 of the sliding member 250 is formed with a second blocking structure 256 corresponding to the first blocking structure 246 of the locking member 240. A first side of the second blocking structure 256 is formed with an inclined surface 256a relative to the first blocking structure 246, and a second side of the second blocking structure 256 is formed with a vertical surface 256b relative to the first blocking structure 246. In addition, a lower end of the protrusion block 254 of the sliding member 250 is formed with a sliding inclined surface 258 configured to abut against the guiding inclined surface 232 of the cam 230.

During a process of the driving module 200 being switched from the unlocking state to the locking state, the inclined surface 256a of the second blocking structure 256 is configured to cross the blocking protrusion 246a of the first blocking structure 246, such that the second blocking structure 256 is blocked between the blocking protrusion 246a and the blocking protrusion 246b. When the second blocking structure 256 is located between the blocking protrusion 246a and the blocking protrusion 246b, the vertical surface 256b of the second blocking structure 256 faces the blocking protrusion 246b of the first blocking structure 246. As such, when the locking part 242 of the locking member 240 is engaged with the locking structure 142, arrangement of the first blocking structure 246 and the second blocking structure 256 is configured to prevent the sliding member 250 from rotating, and prevent the locking part 242 of the locking member 240 from being disengaged from the locking structure 142 due to vibration or external force.

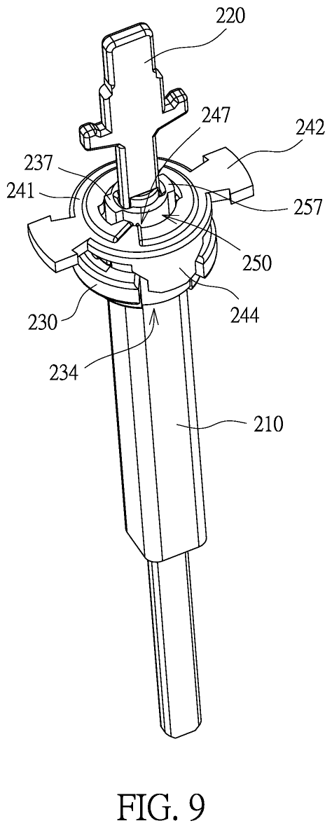

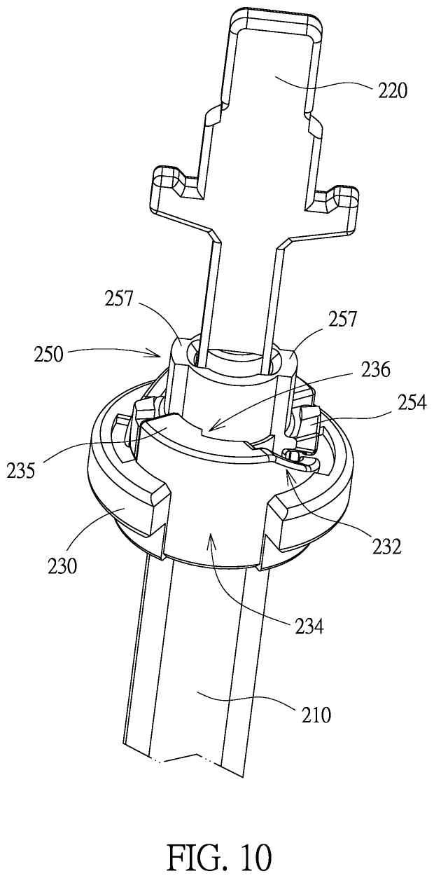

Please refer to FIG. 9 and FIG. 10, and refer to FIG. 6 to FIG. 8 as well. As shown in figures, the sliding member 250 further comprises at least one limiting structure 257 radially protruded from the main body 252. In the present embodiment, the sliding member 250 comprises two limiting structures 257, but the present invention is not limited thereto. When the driving module 200 is in the locking state, a blocking surface 247 of the annular main body 241 of the locking member 240 is configured to block the limiting structure 257 of the sliding member 250, in order to prevent the sliding member 250 (and the driving bar 220) from further rotating along the first rotation direction A. In addition, the protrusion block 254 of the sliding member 250 is configured to stay on a top surface 235 of the cam 230, and a driving protrusion block 236 of the cam 230 is adjacent to the limiting structure 257 of the sliding member 250. In addition to rotating the turning button 320 of the internal lock assembly 300 to drive the driving bar 220 to rotate along the second rotation direction B to switch the driving module 200 back to the unlocking state, a user also can rotate the internal handle 310 to switch the driving module 200 back to the unlocking state. For example, when the driving module 200 is in the locking state shown in FIG. 6, the user can rotate the internal handle 310 along the first rotation direction A. Accordingly, the internal handle 310 further drives the driving shaft 210 and the cam 230 to synchronously rotate along the first rotation direction A relative to the sliding member 250 through the internal rotating cylinder 340 (the blocking surface 247 is configured to block the limiting structure 257 of the sliding member 250), such that the protrusion block 254 of the sliding member 250 is configured to move down from the top surface 235 of the cam 230 along the guiding inclined surface 232 of the cam 230 (an elastic force of the first elastic member 260 is configured to push the sliding member 250 to move down). Therefore, the engaging part 244 of the locking member 240 is engaged with the engaging structure 234 of the cam 230 (the driving module 200 is switched to the unlocking state shown in FIG. 5). On the other hand, when the driving module 200 is in the locking state shown in FIG. 6, the user can also rotate the internal handle 310 along the second rotation direction B. Accordingly, the internal handle 310 further drives the driving shaft 210 and the cam 230 to synchronously rotate along the second rotation direction B, and the driving protrusion block 236 of the cam 230 is configured to abut against the limiting structure 257 of the sliding member 250, in order to drive the sliding member 250 to rotate along with the cam 230 along the second rotation direction B. Thereafter, when the user further rotates the internal handle 310 to return to the initial position along the first rotation direction A (or the user releases the internal handle 310 so that the internal handle 310 is pushed by a recovery element not shown in the figures to return to the initial position along the first rotation direction A), the internal handle 310 is configured to drive the driving shaft 210 and the cam 230 to synchronously rotate along the first rotation direction A relative to the sliding member 250 through the internal rotating cylinder 340, such that the protrusion block 254 of the sliding member 250 is configured to move down from the top surface 235 of the cam 230 along the guiding inclined surface 232 of the cam 230 (the elastic force of the first elastic member 260 is configured to push the sliding member 250 to move down). Therefore, the engaging part 244 of the locking member 240 is engaged with the engaging structure 234 of the cam 230 (the driving module 200 is switched to the unlocking state shown in FIG. 5). The aforementioned unlocking mechanism using the internal handle 310 is the automatic unlocking mechanism of the door lock system of the present invention.

In contrast to the prior art, the driving module of the door lock system of the present invention is configured to drive the sliding member to axially move relative to the driving bar through rotating the driving bar, in order to further drive the locking member to engage with or disengage from the locking structure. Therefore, the driving bar of the present invention does not need to move along the axial direction. In other words, the door lock system of the present invention does not require additional accessories to prevent the driving bar from being separated from the relevant components when it moves. In addition, the door lock system of the present invention does not need to reserve space required by the driving bar for the axial movement. Therefore, mechanism design of the door lock system of the present invention is simpler and has less design restrictions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A door lock system, comprising:
an external lock assembly, comprising:
an external handle; and
a locking structure; and
a driving module, comprising:
a driving shaft configured to drive a latch to move when being rotated;
a driving bar penetrating through the driving shaft and rotatable relative to the driving shaft;
a cam sleeved on the driving shaft and having a guiding inclined surface;
a locking member movably sleeved on the driving bar and arranged between the locking structure and the cam, wherein the locking member is formed with a through hole;
a sliding member slidably sleeved on the driving bar and arranged between the locking member and the cam, wherein one end of the sliding member penetrates through the through hole; and
a first elastic member configured to abut against the end of the sliding member in order to push the sliding member to abut against the guiding inclined surface;
wherein when the driving bar is rotated along a first rotation direction, the sliding member is configured to move toward the locking structure along the guiding inclined surface to push the locking member to engage with the locking structure, in order to prevent the external handle from rotating relative to the locking structure.

2. The door lock system of claim 1, wherein the driving module further comprises a second elastic member configured to abut against the locking member in order to push the locking member to move away from the locking structure.

3. The door lock system of claim 2, wherein when the driving bar is rotated along a second rotation direction, the sliding member is configured to move away from the locking structure along the guiding inclined surface, and the second elastic member is configured to push the locking member to move away from the locking structure to engage with the cam, in order to allow the external handle to rotate relative to the locking structure to further drive the latch to move through the driving shaft.

4. The door lock system of claim 1, wherein the driving bar has a protrusion structure, the first elastic member has a first end abutting against the protrusion structure of the driving bar, and a second end abutting against the end of the sliding member.

5. The door lock system of claim 1, wherein the external lock assembly further comprises a lock cylinder arranged on the external handle, the lock cylinder has an accommodation structure configured to accommodate a first end of the driving bar, the lock cylinder is configured to drive the driving bar to rotate through the accommodation structure when being rotated.

6. The door lock system of claim 1, further comprising an internal lock assembly, wherein the internal lock assembly comprises:
an internal handle;
a turning button arranged on the internal handle;
an internal rotating shaft connected between the turning button and a second end of the driving bar, wherein the turning button is configured to drive the driving bar to rotate through the internal rotating shaft when being rotated; and
an internal rotating cylinder connected between the internal handle and the driving shaft;
wherein when the locking member is engaged with the locking structure and when the internal handle is rotated, the internal handle is configured to drive the driving shaft to rotate through the internal rotating cylinder, in order to rotate the cam relative to the sliding member, such that the sliding member is moved away from the locking structure along the guiding inclined surface, and the second elastic member is configured to push the locking member to move away from the locking structure to engage with the cam.

7. The door lock system of claim 1, wherein the locking member has a first blocking structure configured to prevent the sliding member from rotating when the locking member is engaged with the locking structure.

8. The door lock system of claim 7, wherein the sliding member comprises:
a main body slidably sleeved on the driving bar; and
a protrusion block protruded from the main body, wherein an upper end of the protrusion block is formed with a second blocking structure corresponding to the first blocking structure, the second blocking structure is configured to abut against the first blocking structure to prevent the sliding member from rotating when the locking member is engaged with the locking structure.

9. The door lock system of claim 8, wherein a first side of the second blocking structure is formed with an inclined surface relative to the first blocking structure, and a second side of the second blocking structure is formed with a vertical surface relative to the first blocking structure.

10. The door lock system of claim 8, wherein a lower end of the protrusion block is formed with a sliding inclined surface configured to abut against the guiding inclined surface.

11. A driving module of a door lock system, comprising:
a driving shaft configured to drive a latch to move when being rotated;
a driving bar penetrating through the driving shaft and rotatable relative to the driving shaft;
a cam sleeved on the driving shaft and having a guiding inclined surface;
a locking member movably sleeved on the driving bar and arranged between a locking structure of the door lock system and the cam, wherein the locking member is formed with a through hole;
a sliding member slidably sleeved on the driving bar and arranged between the locking member and the cam, wherein one end of the sliding member penetrates through the through hole; and
a first elastic member configured to abut against the end of the sliding member in order to push the sliding member to abut against the guiding inclined surface;
wherein when the driving bar is rotated along a first rotation direction, the sliding member is configured to move toward the locking structure along the guiding inclined surface to push the locking member to engage with the locking structure.

12. The driving module of claim 11, further comprising a second elastic member configured to abut against the locking member in order to push the locking member to move away from the locking structure.

13. The driving module of claim 12, wherein when the driving bar is rotated along a second rotation direction, the sliding member is configured to move away from the locking structure along the guiding inclined surface, and the second elastic member is configured to push the locking member to move away from the locking structure to engage with the cam.

14. The driving module of claim 11, wherein the driving bar has a protrusion structure, the first elastic member has a first end abutting against the protrusion structure of the driving bar, and a second end abutting against the end of the sliding member.

15. The driving module of claim 11, wherein the locking member has a first blocking structure configured to prevent the sliding member from rotating.

16. The driving module of claim 15, wherein the sliding member comprises:
a main body slidably sleeved on the driving bar; and
a protrusion block protruded from the main body, wherein an upper end of the protrusion block is formed with a second blocking structure corresponding to the first blocking structure, the second blocking structure is configured to abut against the first blocking structure to prevent the sliding member from rotating.

17. The driving module of claim 16, wherein a first side of the second blocking structure is formed with an inclined surface relative to the first blocking structure, and a second side of the second blocking structure is formed with a vertical surface relative to the first blocking structure.

18. The driving module of claim 16, wherein a lower end of the protrusion block is formed with a sliding inclined surface configured to abut against the guiding inclined surface.
